(19) United States
(12) Patent Application Publication
(10) Pub. No.: US 2024/0135418 A1
(43) Pub. Date: Apr. 25, 2024

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Kenji YAMAGUCHI, Miyoshi-shi (JP); Yohei Nakanishi, Nagoya-shi (JP); Yu Hamada, Nagoya-shi (JP)

(73) Assignee: TOYOTA JIDOSHA KABUSHIKI KAISHA, Toyota-shi (JP)

(21) Appl. No.: 18/492,225

(22) Filed: Oct. 22, 2023

(30) Foreign Application Priority Data
Oct. 24, 2022 (JP) 2022-170733

(51) Int. Cl. G06Q 30/0283; G06Q 30/02; G06Q 30/0645

(52) U.S. Cl. CPC G06Q 30/0283; G06Q 30/0278; G06Q 30/0645

(57) ABSTRACT

An information processing apparatus calculates a fee for applying a second coating film including an easily removable layer to a first vehicle having a first coating film applied thereon. The information processing apparatus disclosed herein has a controller that calculates a first fee defined as a fee for applying the second coating film to the first vehicle that is for lease lower than a second fee defined as a fee for applying the second coating film to the first vehicle that is not for lease. In other words, the controller calculates the first fee by subtracting a first subtraction value from the second fee.

### CROSS REFERENCE TO THE RELATED APPLICATION

This application claims the benefit of Japanese Patent Application No. 2022-170733, filed on Oct. 25, 2022, which is hereby incorporated by reference herein in its entirety.

### TECHNICAL FIELD

### Background

The present disclosure relates to an information processing apparatus and an information processing method.

### Description of the Related Art

There is a known technology of applying removable coating including an easily removable layer to a vehicle (for example, see Patent Literature 1 in the citation list below).

### CITATION LIST

### Patent Literature

Patent Literature 1: Japanese Patent Application Laid-Open No. 2022-59901

### SUMMARY

An object of this disclosure is to provide a technology that helps to increase the resale value of vehicles for lease.

In one aspect of the present disclosure, there is provided an information processing apparatus for calculating a first fee for applying a second coating film including an easily removable layer to a first vehicle having a first coating film applied thereon. For example, the information processing apparatus may comprise a controller including at least one processor, and the controller may calculate the first fee defined as a fee for applying the second coating film to the first vehicle when it is for lease lower than a second fee defined as a fee for applying the second coating film to the first vehicle when it is not for lease.

In another aspect of the present disclosure, there is provided an information processing method for calculating a first fee for applying a second coating film including an easily removable layer to a first vehicle having a first coating film applied thereon. For example, in the information processing method, a computer may calculate the first fee defined as a fee for applying the second coating film to the first vehicle when it is for lease lower than a second fee defined as a fee for applying the second coating film to the first vehicle when it is not for lease.

According to other aspects, there are also provided an information processing program configured to cause a computer to implement the above-described information processing method and a non-transitory storage medium in which such an information processing program is stored.

According to the present disclosure, there is provided a technology that helps to increase the resale value of a leased vehicle.

### BRIEF DESCRIPTION OF THE DRAWINGS

FIG. 1 is a diagram illustrating the general configuration of a lease system.

FIG. 2 is a diagram illustrating a first exemplary structure of coating films applied to a first vehicle.

FIG. 3 is a diagram illustrating a second exemplary structure of coating films applied to the first vehicle.

FIG. 4 is a diagram illustrating exemplary functional configurations of a user's terminal and a server included in the lease system.

FIG. 5 is a block diagram illustrating an exemplary functional configuration of the server according to a first embodiment.

FIG. 6 is a graph illustrating a relationship of a first difference and a first subtraction value.

FIG. 7 illustrates an example of a second webpage displayed on the user's terminal.

FIG. 8 illustrates an example of information stored in a first appraisal information database according to the first embodiment.

FIG. 9 illustrates an example of information stored in a second appraisal information database according to the first embodiment.

FIG. 10 is a graph illustrating a relationship of the lease term length, the color of a first coating fil, and the first difference.

FIG. 11 illustrates an example of information stored in a standard fee database according to the first embodiment.

FIG. 12 is a flow chart of a process executed in the server according to the first embodiment.

FIG. 13 is a block diagram illustrating an exemplary functional configuration of the server according to a modification of the first embodiment.

FIG. 14 is a diagram schematically illustrating a first appraisal model according to the modification of the first embodiment.

FIG. 15 is a diagram schematically illustrating a second appraisal model according to the modification of the first embodiment.

FIG. 16 is a diagram illustrating an exemplary functional configuration of the server according to a second embodiment.

FIG. 17 illustrates an example of information stored in a third appraisal information database according to the second embodiment.

FIG. 18 is a diagram illustrating an exemplary functional configuration of the server according to a modification of the second embodiment.

FIG. 19 is a diagram schematically illustrating a third appraisal model according to the modification of the second embodiment.

### DESCRIPTION OF THE EMBODIMENTS

A technology has been developed to apply a coating to a vehicle body using a coating film (referred to as the second coating film) that incorporates an easily removable layer. The second coating film is applied over the original coating (referred to as the first coating film) applied to the vehicle body in the process of manufacturing the vehicle and can be removed later. The first coating film is produced by forming an electrolytic deposition layer (or primer coat) on the steel plate constituting the vehicle body and laminating an intercoat layer, a base layer, and a clear layer (or topcoat) on the electrolytic deposition layer. The first coating film is not easily removable, because its removal requires the use of a special solution, such as a remover. In contrast, for example, the second coating film incorporates an easily removable layer in the form of a film formed on the first coating film and a coating film (for example, a film including a base layer and a clear layer) formed on the easily removable layer, and can be easily removed without the use of a special solution. The second coating film itself may be a film that can be removed (i.e., easily removable coating).

In the case of vehicles to which the aforementioned second coating film is applied, the first coating film is protected by the second coating film. Therefore, the first coating film of such vehicles is less likely to be subject to deterioration (e.g., fading and scratches) than vehicles to which the second coating film is not applied. For example, the second coating film can be applied to a vehicle for lease before it is leased. This reduces the deterioration of the first coating film during the lease term. As a result, after the end of the lease term, the leasing service provider can easily find a second user (e.g., the next lessee or buyer) of the vehicle and can lease or sell the vehicle at a higher fee or price. Therefore, it is desired to increase the number of users who want to apply the second coating film to vehicles for lease in order to increase the resale value of the vehicles for lease.

In view of the above, the controller of the information processing apparatus according to the present disclosure is configured to calculate the fee for applying the second coating film as an overcoat lower when a first vehicle to which the second coating film is applied is a vehicle for lease than when the first vehicle is a vehicle not for lease. Here, the first fee is defined as a fee for applying the second coating film to the first vehicle that is a vehicle for lease, and the second fee is defined as a fee for applying the second coating film to the first vehicle that is a vehicle not for lease. The information processing apparatus according to the present disclosure calculates the first fee lower than the second fee. The “vehicle not for lease” mentioned here is a vehicle of which the leasing service provider cannot necessarily enjoy the merit of applying the second coating film. Examples of the vehicles not for lease include vehicles for sale or vehicles that have already been sold. The “fee for applying the second coating film” includes the cost of materials and labor, and it is charged to the user of the first vehicle.

According the present disclosure, the fee for applying the second coating film that is charged to the user of the first vehicle is made lower when the first vehicle is a vehicle for lease than when it is a vehicle not for lease. This can make the financial barrier for users regarding the application of the second coating film lower for vehicles for lease than vehicles not for lease. Therefore, it is possible to increase the number of users who want to apply the second coating film to vehicles for lease.

The controller of the information processing apparatus according to the present disclosure may be configured to calculate the first fee by subtracting a first subtraction value from the second fee. This makes the first fee lower than the second fee.

To calculate the first subtraction value, the controller may obtain a predicted value of the appraisal price of the first vehicle at the end of the lease term under the assumption that the second coating film is applied to it (which will be referred to as the “first residual value”) and calculate the first subtraction value on the basis of the first residual value. The first residual value is the residual value that is calculated under the assumption that the first coating film will be protected by the second coating film. The first residual value is set higher than a predicted value of the appraisal price of the first vehicle at the end of the lease term that is calculated under the assumption that the second coating film is not applied to the first vehicle (which will be referred to as the “second residual value”).

The larger the excess of the first residual value over the second residual value is, the larger the controller of the information processing apparatus according to the present disclosure may calculate the first subtraction value. In this way, it is possible to calculate the first subtraction value according to the increase in the residual value of the first vehicle resulting from the application of the second coating film. As a result, the user of the first vehicle can be granted with a discount of the fee for applying the second coating film according to the increase in the residual value of the first vehicle resulting from the application of the second coating film.

The difference between the first residual value and the second residual value is mainly due to the presence or absence of deterioration of the first coating film (e.g., color fading and scratches). The first residual value is a residual value that is calculated assuming that the first coating film will deteriorate little during the lease term, while the second residual value is a residual value that is calculated assuming that the first coating film will deteriorate during the lease term.

In the case where the second coating film is not applied, the degree of deterioration of the first coating film changes depending on the lease term length and the color of the first coating film. For example, scratches or other deterioration of the first coating film tend to increase as the lease term length increases.

The degree of color fading per unit time of the first coating film tends to be greater when the first coating film has a color that tends to absorb a lot of ultraviolet light than when the first coating film has a color that tends not to absorb ultraviolet light. Examples of the color that tends to absorb a lot of ultraviolet light include black and solid colors. Examples of the color that tends not to absorb ultraviolet light include colors that contain bright particles such as metallic colors or pearl colors and white.

In view of the above, the controller of the information processing apparatus according to the present disclosure may be configured to obtain information on the color of the first coating film of the first vehicle and information on the lease term length, and to obtain the first residual value based on the obtained information. In this case, the information processing apparatus according to the present disclosure may be provided with a first database that stores colors of the first coating film, lease term lengths, and first residual values in a linked manner. The controller may access the first database using the color of the first coating film of the first vehicle and the lease term length as arguments to obtain the first residual value. For example, the first residual values stored in the first database are appraisal prices that are calculated by adding an estimated value representing the merit of protecting the first coating film (or preventing deterioration of the first coating film) by the second coating film to the second residual values. In this way, it is possible to obtain the residual value of the first vehicle at the end of the lease term (i.e., the first residual value) under the assumption that the second coating film is applied to the first vehicle.

The controller of the information processing apparatus according to the present disclosure may obtain the first residual value using a first model instead of the first database. For example, the first model is such a model that takes the color of the first coating film and the lease term length as inputs, and outputs the first residual value. The first model is a machine learning model that is trained using actual appraisal prices on a first market as the training data. For example, the “first market” mentioned above is a market of leased vehicles or a market of used vehicles. The appraisal prices used as the training data are the actual appraisal prices of the vehicles (corresponding to the second residual value mentioned above) that have the same characteristics as the first vehicle in terms of vehicle model, grade, and color of the first coating film and whose usage duration is approximately equal to the lease term length of the first vehicle. For example, the first model is configured to add an estimated value representing the merit of protecting the first coating film (or preventing deterioration of the first coating film) by the second coating film to the actual appraisal price on the first market. In this way, the controller of the information processing apparatus can obtain the residual value (the first residual value) of the first vehicle at the end of the lease term under the assumption that the second coating film is applied to it.

After the end of the lease term of the first vehicle, the leasing service provider may lease (for the second time) or sell the first vehicle without removing the second coating film in some cases. In this case, the leasing service provider can enjoy the following merits.
(1) The first coating film is protected by the second coating film during the second lease term also.
(2) It is possible to claim the selling point that the second user can remove the second coating film at a desired time to restore the first coating film in a fine condition.

The “second user” mentioned above is the user who leases the first vehicle in the second lease or the user who purchases the first vehicle that has been returned to the leasing service provider.

When looking for the second user, the popularity (or demand) for the color of the second coating film is an important factor. The controller of the information processing apparatus according to the present disclosure may obtain information on the color of the first coating film of the first vehicle, the color of the second coating film, and the lease term length, and obtain the first residual value based on the obtained information. In this case, the information processing apparatus according to the present disclosure may be provided with a second database that stores colors of the first coating film, colors of the second coating film, lease term lengths, and first residual values in a linked manner. The controller may access the second database using the color of the first coating film of the first vehicle, the color of the second coating film of the first vehicle, and the lease term length of the first vehicle as arguments to obtain the first residual value. For example, the first residual values stored in the second database are appraisal prices that are calculated by adding an estimated value representing the popularity (or demand) for the color of the second coating film on the first market as well as an estimated value representing the merit of protecting the first coating film by the second coating film to the second residual values. For example, the higher the popularity (or demand) for the color of a second coating film is, the larger the estimated value representing the popularity (or demand) for the color of the second coating film on the first market may be made. Thus, even in cases where the first vehicle is supposed to be leased in the second lease or sold without removing the second coating film, the controller of the information processing apparatus can obtain an appropriate first residual value.

The controller of the information processing apparatus according to the present disclosure may obtain the first residual value using a second model instead of the second database. For example, the second model is such a model that takes the color of the first coating film, the color of the second coating film, and the lease term length as inputs, and outputs the first residual value. The second model is a machine learning model that is trained using actual appraisal prices on the first market as the training data. The appraisal prices (corresponding to the second residual value) used as the training data are the same as those used for the first model. For example, the second model is configured to add an estimated value representing the popularity (or demand) for the color of the second coating film on the first market as well as an estimated value representing the merit of protecting the first coating film by the second coating film to the second residual value. Thus, even in cases where the first vehicle is supposed to be leased in the second lease or sold without removing the second coating film, the controller of the information processing apparatus can obtain an appropriate first residual value.

The controller may determine which of the first or second database/model to use in obtaining the first residual value based on the lease time length of the first vehicle. For example, when the margin of the useful life of the second coating film to the lease time length (i.e. the useful life minus the lease term length) is shorter than a predetermined time length (e.g. a few years), the controller may obtain the first residual value using the first database/model, while when the margin is equal to or longer than the predetermined time length, the controller may obtain the first residual value using the second database/model.

The controller of the information processing apparatus according to the present disclosure may be configured to cause a browser on a user's terminal used by the user of the first vehicle to display a web page that indicates both the first and second fees. This lets the user of the first vehicle be aware of the discount of the fee for applying the second coating film and the amount of discount.

The controller of the information processing apparatus according to the present disclosure may determine the monthly fee for the lease of the first vehicle taking account of the first fee. In this case, the first fee is included in the monthly fee and is paid in installments. This eliminates the need for the user to pay the first fee in lump sum and to go through the process of paying the fee separately from the monthly lease fee.

The information processing apparatus according to the present disclosure may be a server operated by the leasing service provider that leases the first vehicle. This server may be a computer configured to be capable of implementing a web server that can interact with the user's terminal used by the user of the first vehicle. In this case, the user can sign a contract for the lease of the first vehicle and order the application of the second coating film by accessing the web server through the browser on the user's terminal. When ordering the application of the second coating film, the user can specify the color of the second coating film through the browser on the user's terminal. Moreover, the user can view the web page that indicates both the first and second fees through the browser on the user's terminal. The server may implement the function equivalent to the web server described above by executing the service of interacting with a special application program installed in the user's terminal using a specific protocol.

In another aspect, the technology disclosed herein can be identified as an information processing method that is implemented by a computer that executes the processing of the information processing apparatus described above. The information processing method can accomplish the advantageous effects same as the information processing apparatus described above. In still another aspect, the technology disclosed herein can also be identified as a program configured to cause a computer to execute the processing of the information processing apparatus described above or a non-transitory storage medium that stores such a program.

In the following, specific embodiments of the technology disclosed herein will be described with reference to the drawings. It should be understood that hardware configurations, module configurations, and functional configurations that will be described in the following description of the embodiments are not intended to limit the technical scope of the disclosure only to them, unless otherwise stated.

### First Embodiment

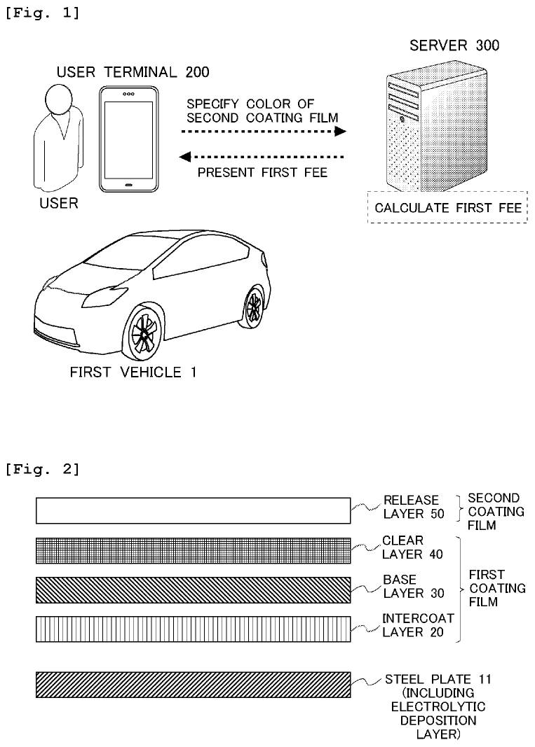

A first embodiment of the technology disclosed herein will be described with reference to FIGS. 1 through 12. In the following description of the embodiment, a case where the information processing apparatus according to the present disclosure is applied to a system that provides a vehicle leasing service will be described. This system will also be referred to as the “lease system” hereinafter.

(General Configuration of System)

FIG. 1 is a diagram illustrating the generation configuration of the lease system according to the embodiment. The lease system according to the embodiment includes a user's terminal 200 and a server 300. When there are multiple users who want to lease vehicles, the system can include user's terminals 200 as many as the users, though FIG. 1 illustrates only one user's terminal 200.

The user's terminal 200 is a computer used by a user who wants to lease a first vehicle 1. The user can access the server 300 through the user's terminal 200 to apply for a leasing contract for the first vehicle 1. This leasing contract includes a process relating to ordering the application of a second coating film. While the following description of the embodiment is directed to a case where the leasing contract is signed online, the leasing contract may be signed in a store (e.g., a store of the leasing service provider). In the latter case, the user's terminal 200 may be a computer installed in the store.

The server 300 is a computer operated by the leasing service provider. The server 300 interacts with the user's terminal 200 to determine the specifications of the first vehicle 1 to be leased to the user and to complete the leasing contract. In the course of the leasing contract, the server 300 according to the embodiment receives the specification of the color of the second coating film, which will be described later, and determine the fee for applying the second coating film (first fee). The server 300 informs the user of the first fee determined as above through the user's terminal 200.

(Second Coating Film)

The coating applied to the first vehicle 1 will now be described. FIG. 2 is a diagram illustrating the general structure of coating films applied to the first vehicle 1. As illustrated in FIG. 2, the first vehicle 1 has an original coating film (the first coating film) applied to the steel plate 11 that constitutes the body of the first vehicle 1, and an overcoating film (the second coating film) is applied over the first coating film. The first coating film includes an intercoat layer 20 formed on the surface of the steel plate 11, a base layer 30 formed on the intercoat layer 20, and a clear layer (or topcoat) 40 formed on the base layer 30. The steel plate 11 is coated with an electrolytic deposition layer as a primer. In the case where the material constituting the body of the first vehicle 1 is a resin, a primer layer may be formed instead of the intercoat layer 20 of the first coating film. The first coating film formed as above cannot be removed easily, because its removal requires a special solution, such as a remover.

The second coating film includes a release layer 50 formed on the surface of the first coating film (namely, on the surface of the clear layer 40). The release layer 50 is a layer of an easily-removable (or easily releasable) coating material, which can be removed easily by applying force. For example, the release layer 50 is formed by applying an easily-removable coating material over the original coating film by spraying. An example of the easily-removable coating material is a coating material containing xylene, ethylbenzene, antioxidant, methyl ethyl ketone, silica reactant, titanium oxide (in the form of nanoparticles), and an organic solvent. The second coating film may include the release layer 50 and a clear layer formed on the surface of the release layer 50.

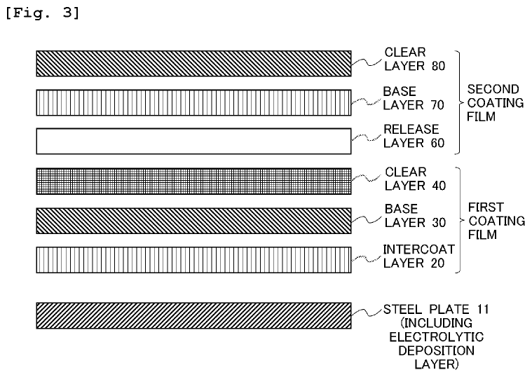

The second coating film illustrated in FIG. 2 uses a paint material that is inherently removable or releasable. However, the structure of the second coating film is not limited to that illustrated in FIG. 2, but the second coating film may be any coating film that can be removed easily. For example, as illustrated in FIG. 3, a release layer 60 may be formed on the clear layer 40 of the first coating film, and a base layer 70 and a clear layer 80 may be formed on the release layer 60. The release layer 60 illustrated in FIG. 3 is a non-tinted layer made of the same material as the release layer 50 in FIG. 2. In this case, the release layer 60 corresponds to the easily-removable layer according to the present disclosure, and the coating film including the release layer 60, the base layer 70, and the clear layer 80 correspond to the second coating film according to the present disclosure. The second coating film illustrated in FIG. 3 can be removed easily from the first coating film by applying force to the release layer 60.

By using the second coating film as above, the body color of the first vehicle 1 can easily be changed to a color different from the color of the first coating film. The body color of the first vehicle 1 can easily be changed back to the color of the first coating film by removing the second coating film. Therefore, for example, if the user cannot find a color he or she wants among the available color options of the first coating film, the user can select the first coating film having a color that has high popularity (demand) in a first market (e.g. a market of leased vehicles or a market of used vehicles) and use the first vehicle 1 after applying the second coating film having a color that he or she wants. After the lease term expires, the leasing service provider can remove the second coating film from the first vehicle 1 to restore the first coating film, which has high popularity (demand) on the first market. As a result, it is easy to find the second user (namely, the next lessee or purchaser) of the first vehicle 1, and it is also possible to lease the first vehicle 1 in the second lease or to sell the first vehicle at a higher fee or price.

In view of the above, the server 300 according to the first embodiment is configured to calculate the fee (first fee) for applying the second coating film to the first vehicles 1 for lease lower than the fee (second fee) for applying the second coating film to vehicles not for lease. In consequence, users can order the application of the second coating layer at a smaller fee for the vehicles for lease. This can lead to an increase in the number of users who want the application of the second coating film when making a leasing contract.

(System Configuration)

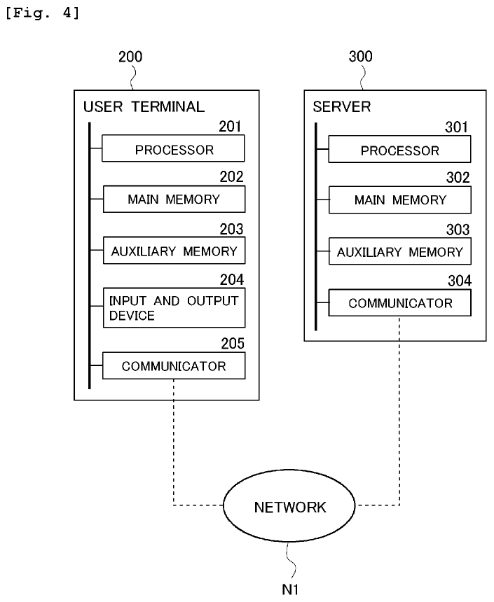

FIG. 4 is a diagram illustrating an example of the respective hardware configurations of the user's terminal 200 and the server 300 included in the lease system according to this embodiment.

The user's terminal 200 is a personally-used computer, such as a personal computer, a smartphone, a cellular phone, a tablet computer, or a personal information terminal. The user's terminal 200 has a processor 201, a main memory 202, an auxiliary memory 203, an input and output unit 204, and a communicator 205. The processor 201, the main memory 202, the auxiliary memory 203, the input and output unit 204, and the communicator 205 are interconnected by system buses.

FIG. 4 illustrates only the hardware components that are used to execute the processing related to the leasing service among the hardware components of the user's terminal 200. The user's terminal 200 may have hardware components other than those illustrated in FIG. 4 also, examples of which include a hardware component used to determine the present location of the user's terminal 200 and a hardware component for outputting sound.

The processor 201 is an arithmetic processing unit such as a CPU (Central Processing Unit) or a DSP (Digital Signal Processor). The processor 201 loads a program stored in the auxiliary memory 203 into the main memory 202 and executes it to control the user's terminal 200.

The main memory 202 includes a semiconductor memory, such as a RAM (Random Access Memory) and a ROM (Read Only Memory). The main memory 202 provides a storage area and a work area into which programs stored in the auxiliary memory 203 are loaded. The main memory 202 is also used as a buffer for the processing executed by the processor 201.

For example, the auxiliary memory 203 includes an EPROM (Erasable Programmable ROM) or an HDD (Hard Disk Drive). The auxiliary memory 203 may include a removable medium or a portable recording medium. Examples of the removable medium include a USB (Universal Serial Bus) memory and a disc recording medium, such as a CD (Compact Disc) or a DVD (Digital Versatile Disc). The auxiliary memory 203 stores various programs and data used by the processor 201 when executing the programs.

The programs stored in the auxiliary memory 203 include an operating system (OS), a browser application program or a special application program for causing the processor 201 to execute the processing related to the leasing service.

The input and output unit 204 receives input operations conducted by the user and presents information to the user. The input and output unit 204 according to the embodiment is composed of a touch panel display. The input and output unit 204 includes a touch panel display and a control circuit for it.

The communicator 205 is an interface to connect the user's terminal to a network N1. For example, the network N1 is a WAN (Wide Area Network), which is a global public communication network such as the Internet, or other communication network. The communicator 205 is connected to the network N1 using mobile communications, such as LTE (Long Term Evolution), LTE-Advanced, 5G (5th Generation), or 6G (6th Generation) mobile communications, wireless communications, such as Wi-Fi (registered trademark) or a LAN (Local Area Network). The communicator 205 according to the embodiment communicates with the server 300 through the network N1.

The server 300 is a computer operated by the leasing service provider. The server 300 has a processor 301, a main memory 302, an auxiliary memory 303, and a communicator 304. The processor 301, the main memory 302, the auxiliary memory 303, and the communicator 304 are interconnected by system buses.

FIG. 4 illustrates only the hardware components that are used to execute the processing related to the leasing service among the hardware components of the server 300. The server 300 may include hardware components other than those illustrated in FIG. 4, examples of which include hardware components used to perform operations related a service other than the leasing service, a hardware component for receiving input operations conducted by the operator, and a hardware component for presenting information to the operator.

The processor 301, the main memory 302, the auxiliary memory 303, and the communicator 304 of the server 300 are respectively similar to the processor 201, the main memory 202, the auxiliary memory 203, and the communicator 205 of the user's terminal 200 and will not be described in further detail. The programs stored in the auxiliary memory 303 of the server apparatus 300 include a program for implementing a web server to interact with the user's terminal 200 in addition to the operating system. The data stored in the auxiliary memory 303 includes various data needed to calculate the fee for applying the second coating film.

(Functional Configuration of Server)

The server 300 according to the embodiment is configured to be capable of implementing a web server to interact with the user's terminal 200. Specifically, according to the embodiment, the user's terminal 200 accesses a site provided by the web server through the browser to follow the process of completing a leasing contract including an order for the application of the second coating film. The server 300 may provide the above-described service by means other than the web server. For example, the server 300 may implement a service to interact with special application software installed in the user's terminal 200 using a specific protocol.

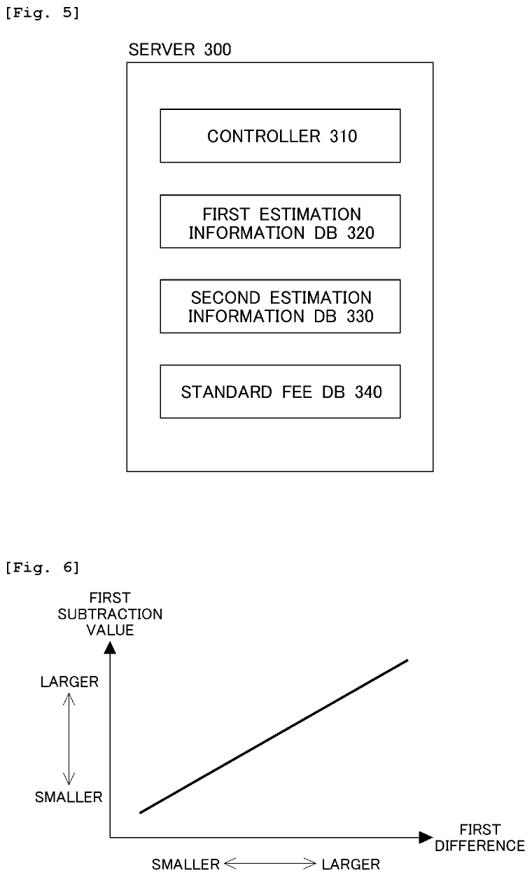

FIG. 5 is a block diagram illustrating an example of the functional configuration of the server 300. As illustrated in FIG. 5, the server 300 according to the embodiment has, as functional components, a controller 310, a first appraisal information database 320, a second appraisal information database 330, and a standard fee database 340. The functional configuration of the sever 300 is not limited to the configuration illustrated in FIG. 5, but some components may be removed, replaced by other components, or added fitly.

The controller 310 is implemented by the processor 301 of the server apparatus 300 by loading a program stored in the auxiliary memory 303 into the main memory 302 and executing it. The controller 310 may be implemented partly or entirely by a hardware circuit, such as an ASIC (Application Specific Integrated Circuit) or an FPGA (Field Programmable Gate Array).

The controller 310 interacts with the user's terminal 200 by executing the web server. According to the embodiment, the controller 310 causes the browser on the user's terminal 200 to display a first web page that prompts the user to input the desired specifications of the first vehicle 1 for which the user wants to sign a leasing contract. The first web page has the following entry items.
Entry Item 1: The model of the first vehicle 1
Entry Item 2: The grade of the first vehicle 1
Entry Item 3: The color of the first coating film of the first vehicle 1
Entry Item 4: The color of the second coating film of the first vehicle 1
Entry Item 5: Options etc.
Entry Item 6: The lease term length

The above entry items may be displayed in such a way that the user can select the desired specifications from pull-down menus. Even in this case, Entry Item 4 may be arranged in such a way as to allow the user to specify any desired color of the second coating film.

The first coating film is the original coating film that is applied to the vehicle body in the process of manufacturing the first vehicle 1. Therefore, the color that the user can select in Entry Item 3 is limited to one of the colors set by the manufacturer of the first vehicle 1. In contrast, the second coating film is a coating film that is applied over the first coating film and can be removed later. Therefore, the user is allowed to choose the color of the second coating film in Entry Item 4 from a larger number of colors than the number of colors of the first coating film. The color of the second coating film can be customized according to the user's order. In this case, even when the color desired by the user is not found in the available options of the first coating film, the user can change the body color of the first vehicle 1 into the desired color by specifying the color of the second coating film.

While Entry Items 1, 2, 3 and 6 are mandatory entry items that the user must enter, Entry Items 4 and 5 are optional. In other words, it is up to the user whether to apply the second coating film and whether to add some options. The controller 310 may be configured to automatically determine the color of the first coating film to a predetermined color, only when the color of the second coating film is specified in Entry Item 4. This predetermined color may be a color that has high popularity (demand) on the first market.

In the case where Entry Item 4 is entered in the first web page, in other words, in the case where the color of the second coating film is specified, the controller 310 calculates a first fee. The first fee is the fee for allying the second coating film to the first vehicle 1 (application fee), which is charged to the user. The first fee includes all the cost needed to apply the second coating film to the first vehicle 1 including the cost of the materials and labor.

In the system according to the first embodiment, the first fee is calculated by subtracting a first subtraction value from a second fee. The second fee is the fee for applying the second coating film to a vehicle not for lease. The vehicle not for lease is a vehicle of which the leasing service provider cannot necessarily enjoy the merit of applying the second coating film. Examples of the vehicles not for lease include vehicles for sale or vehicles that have already been sold. The fee for applying the second coating film varies depending on some factors such as the model and the grade of the vehicle. Therefore, the second fee used in the calculation of the first fee is the fee for the vehicles of the same model, grade, and other relevant factors as the first vehicle 1.

The controller 310 obtains the second fee mentioned above by accessing the standard fee database 340 (described later) using the model of the first vehicle 1 and the grade of the first vehicle as arguments.

The controller 310 calculates the first subtraction value mentioned above based on the difference between a first residual value and a second residual value. This difference represents the increase in the residual value resulting from the application of the second coating film. This difference will also be referred to as the “first difference” hereinafter. The first residual value is a predicted value of the appraisal price of the first vehicle 1 at the end of the lease term that is predicted under the assumption that the second coating film is applied to it. The second residual value is the predicted value of the appraisal price of the first vehicle 1 at the end of the lease term that is predicted under the assumption that the second coating film is not applied to it.

The controller 310 obtains the first residual value by accessing the first appraisal information database 320 (described later) using the model of the first vehicle 1, the grade of the first vehicle 1, the color of the first coating film of the first vehicle 1, and the lease term length of the first vehicle 1 as arguments. The controller 310 obtains the second residual value by accessing the second appraisal information database 330 (described later) using the model of the first vehicle 1, the grade of the first vehicle 1, the color of the first coating film of the first vehicle 1, and the lease term length of the first vehicle 1 as arguments.

The controller 310 calculates the first difference, which represents the increase in the residual value resulting from the application of the second coating film, by subtracting the second residual value from the first residual value. The controller 310 calculates the first subtraction value based on the first difference. For example, the larger the first difference is, the larger the controller 310 calculates the first subtraction value as illustrated in FIG. 6. The relationship as illustrated in FIG. 6 may be stored in the auxiliary memory 303 of the server 300 in the form of a map or a function expression in advance. Then, the controller 310 can calculate the first subtraction value by accessing this map or function expression using the first difference as an argument.

The method of determining the first fee is not limited to the method described above, but what is important to the method is that the first fee is discounted from the second fee according to the increase in the residual value resulting from the application of the second coating film.

The controller 310 according to the embodiment executes the processing of including the first fee in the monthly lease fee of the first vehicle 1. For example, the controller 310 divides the first fee by the number of times of paying the monthly lease fee (i.e., the number of months through which the monthly fee is paid) to calculate the fee per month. Then, the controller 310 adds the fee per month to the standard amount of payment per month to determine the monthly lease fee. The standard amount of payment is the amount of payment per month that is determined according to the model and the grade of the first vehicle 1, the options, and the lease term length.

After determining the first fee and the monthly lease fee as above, the controller 310 causes the browser on the user's terminal 200 to display a second web page. The second web page is a web page that indicates both the first and second fees.

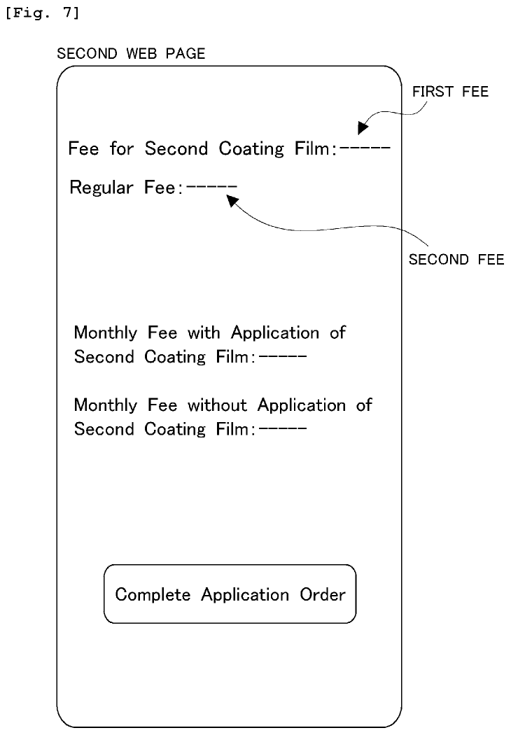

FIG. 7 illustrates an example of the second web page that is displayed on the input and output unit 204 by the browser on the user's terminal 200. In the example illustrated in FIG. 7, the first fee is illustrated as the “Fee for the Second Coating Film”, and the second fee is illustrated as the “Regular Fee”. Thus, the user can be aware of the discount of the fee for applying the second coating film to the vehicle for lease. The exemplary second web page illustrated in FIG. 7 illustrates the monthly lease fee in the case where the second coating film is applied and the monthly lease fee in the case where the second coating film is not applied. Thus, the user can see how much the monthly fee will increase if he or she orders the application of the second coating film. When the user presses the “Complete Application Order” button, the order for the application of the second coating film is completed.

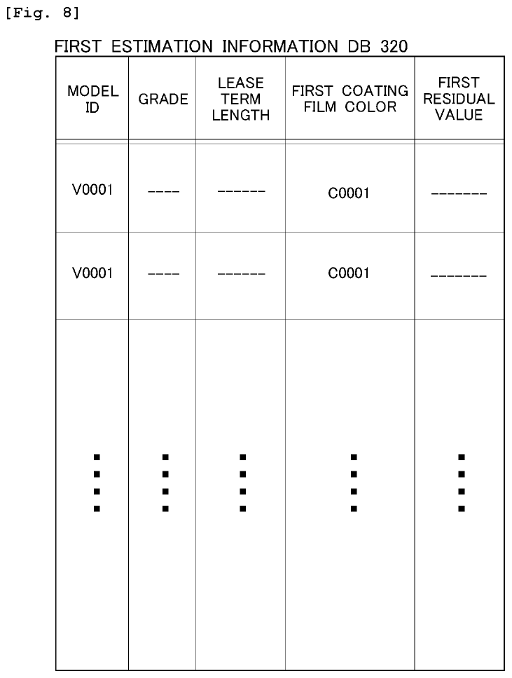

Referring back to FIG. 5, the first appraisal information database 320 stores first residual values for different specifications of vehicles. FIG. 8 illustrates an example of the information stored in the first appraisal information database 320. The first appraisal information database 320 in the system according to the embodiment has multiple records for different specifications of vehicles. These records will also be referred to as the “first residual value records” hereinafter. As illustrated in FIG. 8, each first residual value record has the fields of model ID, grade, lease term length, first coating film color, and first residual value. The structure of the first residual value record is not limited to the example illustrated in FIG. 8, but some fields may be added, changed, or deleted fitly.

What is stored in the model ID field is information (model ID) that identifies each vehicle model. What is stored in the grade field is information that distinguishes the grades set for the vehicle models. What is stored in the lease term field is information indicating the lease term length. What is stored in the first coating film color field is information that distinguishes the colors of the first coating film. What is stored in the first residual value field is the first residual value of the vehicle that is of the model and the grade specified in each record and has the first coating film color specified in each record. As described above, the first residual value is a predicted value of the vehicle at the end of the lease term that is predicted under the assumption that the second coating film is applied to the vehicle.

The first appraisal information database 320 in the system according to the embodiment corresponds to the first database according to the present disclosure.

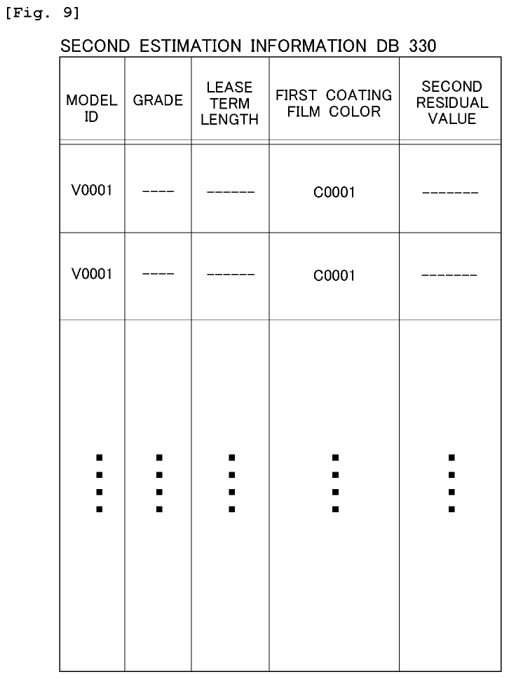

Referring back to FIG. 5, the second appraisal information database 330 stores second residual values for different specifications of vehicles. FIG. 9 illustrates an example of the information stored in the second appraisal information database 330. The second appraisal information database 330 in the system according to the embodiment has multiple records for different specifications of vehicles. These records will also be referred to as the “second residual value records” hereinafter. As illustrated in FIG. 9, each second residual value record has the fields of model ID, grade, lease term length, first coating film color, and second residual value. The structure of the second residual value record is not limited to the example illustrated in FIG. 9, but some fields may be added, changed, or deleted fitly.

The information stored in the model ID field, the grade field, the lease term length field, and the first coating film color field of the second residual value record is the same as the information stored in the model ID field, the grade field, the lease term length field, and the first coating film color field of the first residual value record, and will not be described in further detail. What is stored in the second residual value field is the second residual value of the vehicle that is of the model and the grade specified in each record and has the first coating film color specified in each record. As described above, the second residual value is a predicted value of the vehicle at the end of the lease term that is predicted under the assumption that the second coating film is not applied to the vehicle. The information stored in the second residual value field may be determined based on the appraisal prices of vehicles on the first market. Specifically, the second residual value may be set equal to the actual appraisal price on the first market of the vehicles that have the same characteristics as the first vehicle 1 in terms of model, grade, and color of the first coating film and whose usage duration is approximately equal to the lease term length of the first vehicle 1. In this case, the information stored in the second residual value field is updated according to the prices on the first market.

The difference between the first residual value and the second residual value of vehicles having the same specifications is mainly due to the presence or absence of deterioration of the first coating film (e.g., color fading and scratches). The first residual value is a residual value that is calculated assuming that the first coating film will deteriorate little during the lease term, while the second residual value is a residual value that is calculated assuming that the first coating film will deteriorate during the lease term. In other words, the first residual value is a value calculated by adding an increase in the residual value due to the protection of the first coating film by the second coating film (or due to little deterioration of the first coating film) to the second residual value.

In the case where the second coating film is not applied, the degree of deterioration of the first coating film changes depending on the lease term length and the color of the first coating film. For example, scratches or other deterioration of the first coating film tend to increase as the lease term length increases. The degree of color fading of the first coating film tends to be greater when the first coating film has a color that tends to absorb a lot of ultraviolet light than when the first coating film has a color that tends not to absorb ultraviolet light. Examples of the color that tends to absorb a lot of ultraviolet light include black and solid colors. Examples of the color that tends not to absorb ultraviolet light include colors that contain bright particles such as metallic colors or pearl colors and white.

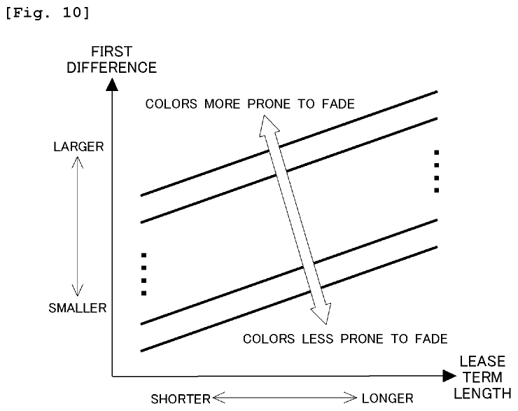

Therefore, the effect of the application of the second coating film for the vehicles having the same specifications increases as the lease term length increases, and as the tendency of the color fading of the first coating film increases, in other words, as the degree of color fading per unit time (e.g. between several month and one year) increases. According to the embodiment, as illustrated in FIG. 10, the first appraisal information database 320 is constructed in such a way that the longer the lease term length is, and the more the color of the first coating film is prone to fade (the greater the degree of color fading per unit time is), the larger the increase of the first residual value of the vehicles having the same specifications from their second residual value (the first difference) is.

In the case where the first residual value is determined based on the relationship illustrated in FIG. 10, when the second residual value is updated according to the prices on the market, the first residual value is also updated accordingly.

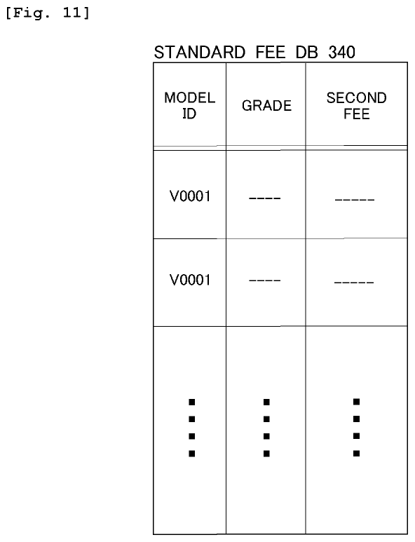

Referring back to FIG. 5, the standard fee database 340 stores the second fee for different specifications of vehicles. FIG. 11 illustrates an example of the information stored in the standard fee database 340. The standard fee database 340 in the system according to the embodiment has multiple records for different specifications of vehicles. These records will also be referred to as the “standard fee records” hereinafter. As illustrated in FIG. 11, each standard fee record has the fields of model ID, grade, and second fee. The structure of the standard fee record is not limited to the example illustrated in FIG. 11, but some fields may be added, changed, or deleted fitly.

What is stored in the model ID field is information (model ID) that identifies each vehicle model. What is stored in the grade field is information that distinguishes the grades set for the vehicle models. What is stored in the second fee field is the second fee for the vehicle that is of the model and the grade specified in each record. The information stored in the second fee field is a fee (application fee) for applying the second coating film to a vehicle not for lease.

(Process Executed in Server)

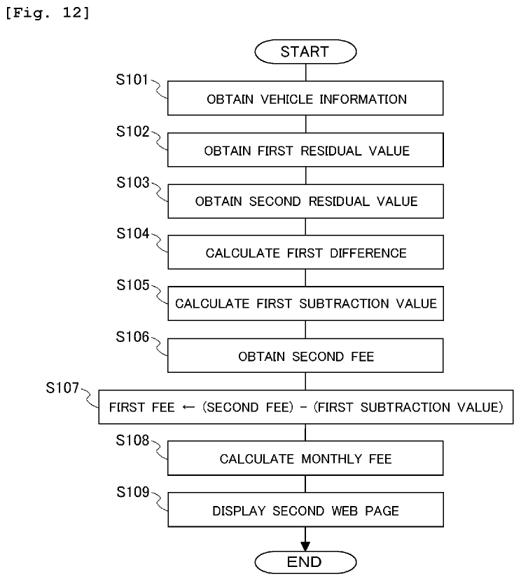

A process executed in the server 300 according to the embodiment will be described with reference to FIG. 12. FIG. 12 is a flow chart of a processing routine executed in the server 300, which is triggered by the specification of the color of the second coating film in the first web page (namely, the entry of the color of the second coating film in Entry Item 4). While the processing routine according to the flow chart of FIG. 12 is executed by the processor 301 of the server 300, functional component (the controller 310) of the server 300 will be mentioned in the following description as the components that execute the processing in the routine.

When the first web page is displayed on the input and output unit 204 by the browser on the user's terminal 200, and the color of the second coating film is specified in Entry Item 4, the controller 310 of the sever 300 obtains vehicle information (step S101). The vehicle information is information on the specifications of the first vehicle 1 that the user wants to lease. The vehicle information includes the model ID of the first vehicle 1, information on the grade of the first vehicle 1, information on the lease term length of the first vehicle 1, and the color of the first coating film of the first vehicle 1. The vehicle information is sent from the user's terminal 200 to the server 300 when the user specifies Entry Items 1, 2, 3 and 6 in the first web page, and the controller 310 obtains it. After completing the processing of step S101, the controller 310 executes the processing of step S102.

In step S102, the controller 310 obtains the first residual value of the first vehicle 1. Specifically, the controller 310 accesses the first appraisal information database 320 using the vehicle information obtained in step S101 as an argument to find a first residual value record that matches the vehicle information. Specifically, the controller 310 finds a first residual value record that satisfies the following conditions.
Condition 1: The information stored in the model ID field is identical to the model ID in the vehicle information.
Condition 2: The information stored in the grade field is identical to the grade specified in the vehicle information.
Condition 3: The information stored in the lease term length field is equal to the lease term length specified in the vehicle information.
Condition 4: The information stored in the first coating film color field matches the color of the first coating film specified in the vehicle information.

The controller 310 retrieves the information stored in the first residual value field of the first residual value record found as above to obtain the first residual value of the first vehicle 1. After completing the processing of step S102, the controller 310 executes the processing of step S103.

In step S103, the controller 310 obtains the second residual value of the first vehicle 1. Specifically, the controller 310 accesses the second appraisal information database 330 using the vehicle information obtained in step S101 as an argument to find a second residual value record that matches the vehicle information. Specifically, the controller 310 finds a second residual value record that satisfies the following conditions.
Condition 5: The information stored in the model ID field is identical to the model ID in the vehicle information.
Condition 6: The information stored in the grade field is identical to the grade specified in the vehicle information.
Condition 7: The information stored in the lease term length field is equal to the lease term length specified in the vehicle information.
Condition 8: The information stored in the first coating film color field matches the color of the first coating film specified in the vehicle information.

The controller 310 retrieves the information stored in the second residual value field of the second residual value record found as above to obtain the second residual value of the first vehicle 1. After completing the processing of step S103, the controller 310 executes the processing of step S104.

In step S104, the controller 310 calculates the first difference by subtracting the second residual value obtained in step S103 from the first residual value obtained in step S102. After completing the processing of step S104, the controller 310 executes the processing of step S105.

In step S105, the controller 310 calculates the first subtraction value based on the first difference calculated in step S104. Specifically, the controller 310 calculates the first subtraction value based on the first difference calculated in step S104 and the relationship as illustrated in FIG. 6 described above. After completing the processing of step S105, the controller 310 executes the processing of step S106.

In step S106, the controller 310 obtains the second fee. Specifically, the controller 310 accesses the standard fee database 340 using the model ID and the grade included in the vehicle information obtained in the step S101 as arguments to find a standard fee record that satisfies the following conditions.
Condition 9: The information stored in the model ID field is identical to the model ID in the vehicle information.
Condition 10: The information stored in the grade field is identical to the grade specified in the vehicle information.

The controller 310 retrieves the information stored in the second fee field of the standard fee record found as above to obtain the second fee, which is the fee for applying the second coating film to the first vehicle 1 that is not for lease. After completing the processing of step S106, the controller 310 executes the processing of step S107.

In step S107, the controller 310 calculates the first fee by subtracting the first subtraction value calculated in step S105 from the second fee obtained in step S106. After completing the processing of step S107, the controller 310 executes the processing of step S108.

In step S108, the controller 310 calculates the monthly lease fee (the amount of payment per month) for the first vehicle 1 based on the first fee calculated in step S107. Specifically, the controller 310 divides the first fee by the number of times of payment of the monthly lease fee (i.e., the number of months through which the payment will be made) to calculate the fee per month. Then, the controller 310 adds the fee per month to the standard fee per month to determine the monthly lease fee. After completing the processing of step S108, the controller 310 executes the processing of step S109.

In step S109, the controller 310 creates the second web page as illustrated in FIG. 7 based on the second fee obtained in step S106, the first fee calculated in step S107, and the monthly fee calculated in step S108. The controller 310 causes the input and output unit 204 to display the second web page created as above through the browser on the user's terminal 200.

(Operation and Advantageous Effects of First Embodiment)

According to the first embodiment described above, the fee for applying the second coating film that is charged to the user of the first vehicle 1 is made smaller when the first vehicle 1 is a vehicle for lease than when it is a vehicle not for lease. This can make the financial barrier for users regarding the application of the second coating film lower for vehicles for lease than vehicles not for lease. Therefore, it is possible to increase the number of users who want to apply the second coating film to vehicles for lease. This can lead to an increase in the number of vehicles that will have increased resale value after the end of the lease term. Therefore, it is possible to find a second user of the vehicle after the end of the lease term (namely, a user who leases the first vehicle 1 in the second lease or a user who purchases the first vehicle 1). It is also possible to lease or sell the vehicle at a higher fee or price.

The system according to the first embodiment can cause the user's terminal 200 to display the second web page that indicates both the first and second fees. This lets the user of the first vehicle be aware of the discount of the fee for applying the second coating film and the amount of discount. Moreover, the system according to the first embodiment can present the monthly lease fee in the case of ordering the application of the second coating film and the monthly lease fee in the case of not ordering the application of the second coating film in the second web page. This lets the user know how much the monthly lease fee will be increased if he or she orders the application of the second coating film.

According to the first embodiment, since the first fee is included in the monthly lease fee and can be paid in installments, it is not necessary for the user to pay the first fee in lump sum. Moreover, it is not necessary for the user to go through the process of paying the monthly lease fee and the process of paying the first fee separately.

(Modification of First Embodiment)

According to the first embodiment described above, the controller 310 obtains the first and second residual values using the first appraisal information database 320 and the second appraisal information database 330. Alternatively, the controller 310 may obtain the first and second residual values using machine learning models.

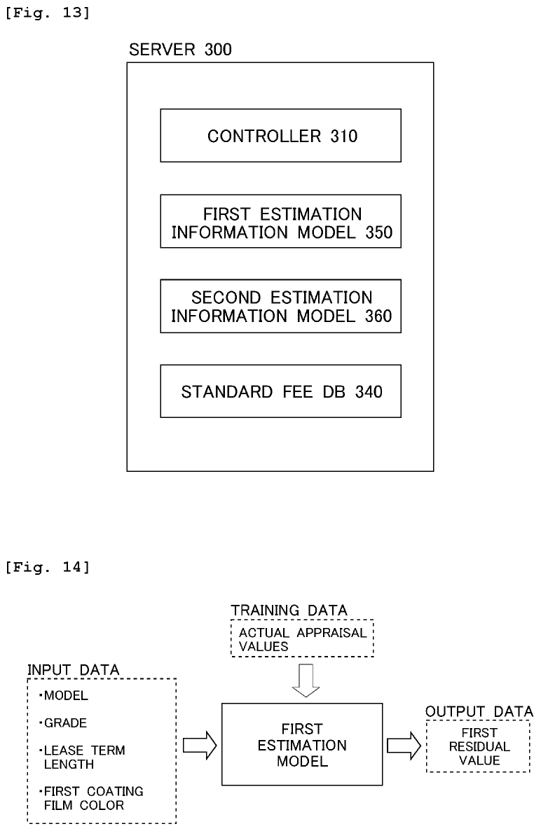

FIG. 13 is a block diagram illustrating an example of the functional configuration of a server 300 according to a modification of the first embodiment. The server 300 according to this modification has, as functional components, a controller 310, a first appraisal model 350, a second appraisal model 360, and a standard fee database 340. The server 300 according to the modification has the first appraisal model 350 and the second appraisal model 360 instead of the first appraisal information database 320 and the second appraisal information database 330 in the system according to the first embodiment.

FIG. 14 is a diagram schematically illustrating the first appraisal model 350. As illustrated in FIG. 14, the first appraisal model 350 is a model that takes the vehicle model, the grade, the lease term length, and the color of the first coating film as input data, and outputs the first residual value as the output data. The first appraisal model 350 is a machine learning model that is constructed using the vehicle model, the grade, the lease term length, and the color of the first coating film as input data and the actual appraisal prices of vehicles having specifications that match the input data on the first market as the training data. The first appraisal model 350 according to the modification is constructed in such a way that an estimated value representing the merit of protecting the first coating film by the second coating film (corresponding to the first difference in the first embodiment) is added to the actual appraisal price on the first market (corresponding to the second residual value in the first embodiment).

The first appraisal model 350 corresponds to the first model according to the present disclosure.

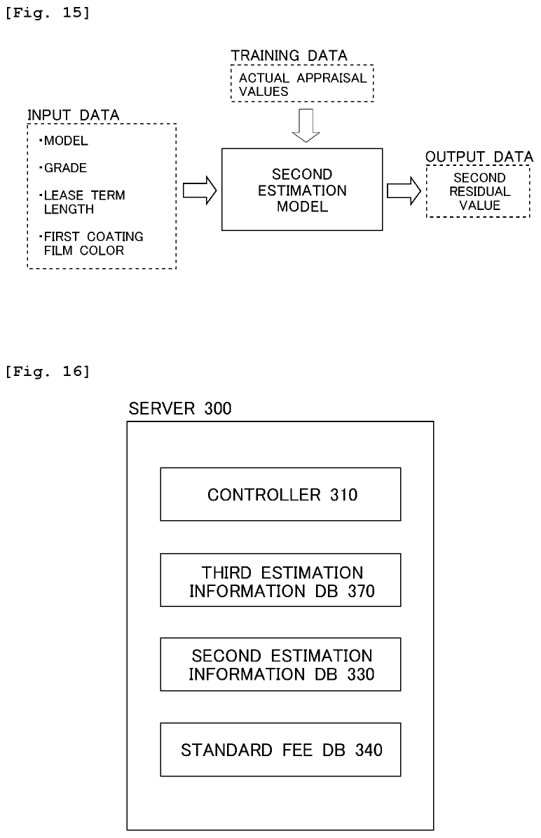

FIG. 15 is a diagram schematically illustrating the second appraisal model 360. As illustrated in FIG. 15, the second appraisal model 360 is a model that takes the vehicle model, the grade, the lease term length, and the color of the first coating film as input data and outputs the second residual value as the output data. The second appraisal model 360 is a machine learning model that is constructed using the vehicle model, the grade, the lease term length, and the color of the first coating film as input data and the actual appraisal prices of vehicles having specifications that match the input data on the first market as the training data. The second appraisal model 360 according to the modification is constructed in such a way that an estimated value representing the merit of protecting the first coating film by the second coating film (corresponding to the first difference in the first embodiment) is not added to the actual appraisal price on the first market (corresponding to the second residual value in the first embodiment).

Referring back to FIG. 13, according to this modification, when the color of the second coating film is specified in Entry Item 4 in the first web page, the controller 310 obtains the vehicle information (i.e., the model ID, the grade, the lease term length, and the color of the first coating film). The controller 310 inputs the obtained vehicle information to the first appraisal model 350 and the second appraisal model 360 to obtain the first residual value and the second residual value. The first difference, the first subtraction value, the second fee, the first fee, and the monthly lease fee are obtained or calculated in the same manner as the first embodiment as described above.

The system according to the modification can operate in the same manner as the system according to the first embodiment described above and accomplish the same advantageous effects as the system according to the embodiment.

### Second Embodiment

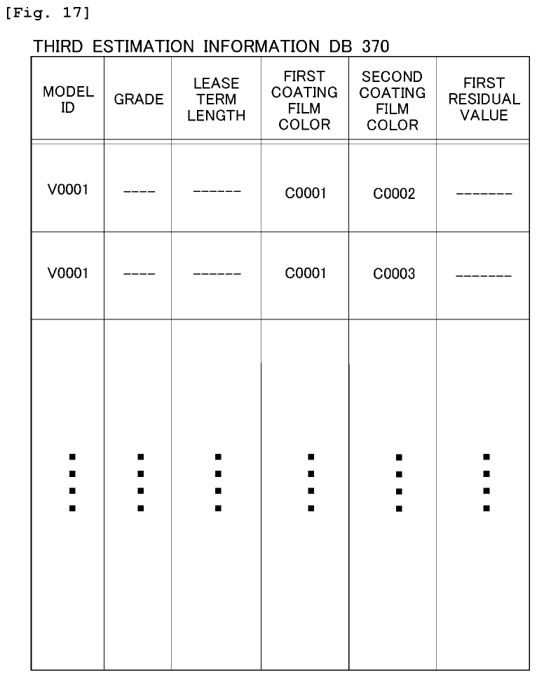

A second embodiment of the present disclosure will be described next with reference to FIGS. 16 and 17. In the following description, the features and functions of the system according to the second embodiment that are different from those in the system according to the first embodiment will be described, but the features and functions that are the same as those in the system according to the first embodiment will not be described in further detail.

The system according to the first embodiment described above is configured to obtain the first residual value using the vehicle model, the grade, the lease term length, and the color of the first coating film as parameters. The system according to the second embodiment that will be described in the following is configured to obtain the first residual value using the color of the second coating film also as a parameter in addition to the vehicle model, the grade, the lease term length, and the color of the first coating film.

FIG. 16 is a diagram illustrating an example of the functional configuration of the server 300 according to the second embodiment. The server 300 according to the second embodiment has, as functional components, a controller 310, a third appraisal information database 370, a second appraisal information database 330, and a standard fee database 340. The server 300 according to the second embodiment has the third appraisal information database 370 instead of the first appraisal information database 320 according to the first embodiment.

The third appraisal information database 370 stores first residual values for different specifications of vehicles. The specifications of vehicles in the system according to the second embodiment include the color of the second coating film in addition to the vehicle model, the grade, the lease term length, and the color of the first coating film. FIG. 17 illustrates an example of the information stored in the third appraisal information database 370. The third appraisal information database 370 in the system according to the second embodiment has multiple records (first residual value records) for different specifications of vehicles. As illustrated in FIG. 17, the first residual value record in the system according to the second embodiment has the second coating film color field in addition to the model ID field, the grade field, the lease term length field, the first coating film color field, and the first residual value field.

What is stored in the second coating film color field is information that distinguishes the colors of the second coating film. What is stored in the first residual value field is the first residual value of the vehicle that is of the model and the grade specified in each record and has the combination of the first coating film color and the second coating film color specified in each record. In the system according to the second embodiment, the first residual value is set by adding an increase in the residual value resulting from the protection of the first coating film by the second coating film and an estimated value representing the popularity (demand) for the second coating film on the first market to the second residual value.

The above setting of the first residual value is made assuming cases where the leasing service provider will lease (in the second lease) or sell the first vehicle 1 without removing the second coating film after the end of the lease term of the first vehicle 1. In such cases, the leasing service provider can enjoy the following merits.
(1) The first coating film is protected by the second coating film during the second lease term also.
(2) It is possible to claim the selling point that the second user can remove the second coating film at a desired time to restore the first coating film in a fine condition.

The estimated value representing the popularity (demand) for a color of the second coating film on the first market may be set in such a way that the higher the popularity (demand) for the color of the second coating film on the first market is, the larger the estimated value is.

The third appraisal information database 370 in the system according to the second embodiment corresponds to the second database according to the present disclosure.

Referring back to FIG. 16, when the color of the second coating film is specified in the first web page, the controller 310 in the system according to the second embodiment obtains vehicle information including information on the color of the second coating film of the first vehicle 1, in addition to the model ID of the first vehicle 1, information on the grade of the first vehicle 1, the lease term length of the first vehicle 1, and the color of the first coating film of the first vehicle 1.

The controller 310 accesses the third appraisal information database 370 using the above vehicle information as an argument to find a first residual value record that matches the vehicle information. In this case, the controller 310 finds a first residual value record that satisfies the aforementioned conditions 1 through 4 and of which the information stored in its second coating film color field matches the color of the second coating film specified in the vehicle record. Then, the controller 310 retrieves the information stored in the first residual value field to obtain the first residual value of the first vehicle 1.

The process of obtaining the second residual value, the process of calculating the first difference, the process of calculating the first subtraction value, the process of obtaining the second fee, the process of calculating the first fee, and the process of calculating the monthly lease fee are performed in the same manner as those in the system according to the first embodiment.

(Operation and Advantageous Effects of Second Embodiment)

According to the second embodiment, it is possible to obtain the first residual value taking account of an estimated value representing the popularity (demand) for the color of the second coating film on the first market in addition to an increase in the estimated value due to the protection of the first coating film by the second coating film. In this way, it is possible to obtain an appropriate first residual value in the case where it is assumed that the first vehicle will be leased in the second lease or sold without removing the second coating film. Therefore, in the case where the first vehicle is supposed to be leased in the second lease or sold without removing the second coating film, the leasing service provider can set a first subtraction value according to the merit that the leasing service provider can enjoy. In consequence, the user can order the application of the second coating film at a decreased fee.

(Modification of Second Embodiment)

According to the second embodiment described above, the controller 310 obtains the first residual value using the third appraisal information database 370. Alternatively, the controller 310 may obtain the first residual value using a machine learning model.

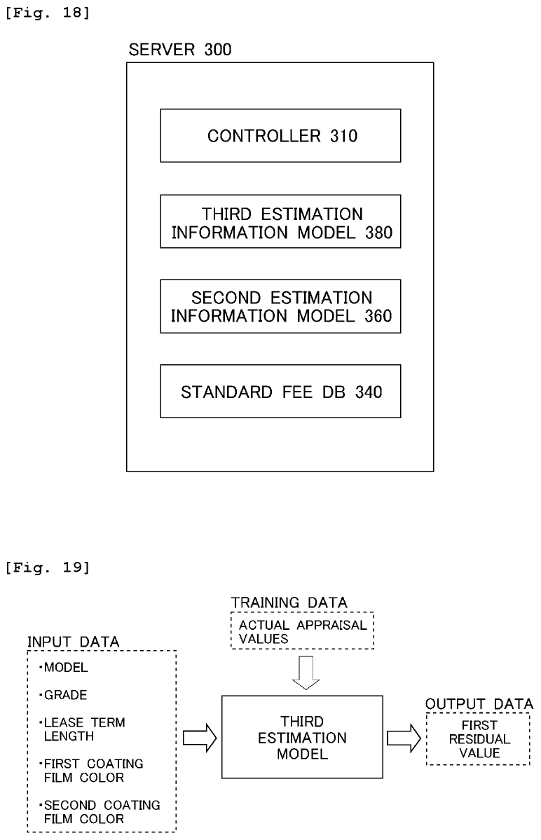

FIG. 18 is a block diagram illustrating an example of the functional configuration of a server 300 according to a modification of the second embodiment. The server 300 according to this modification has, as functional components, a controller 310, a third appraisal model 380, a second appraisal model 360, and a standard fee database 340. The server 300 according to the modification has the third appraisal model 380 and the second appraisal model 360 instead of the third appraisal information database 370 and the second appraisal information database 330. The second appraisal model 360 is the same as the second appraisal model 360 in the system according to the modification of the first embodiment and will not be described in further detail.

FIG. 19 schematically illustrates the third appraisal model 380. As illustrated in FIG. 19, the third appraisal model 380 is a model that takes the vehicle model, the grade, the lease term length, the color of the first coating film, and the color of the second coating film as input data, and outputs the first residual value as the output data. The third appraisal model 380 is a machine learning model that is constructed using the vehicle model, the grade, the lease term length, the color of the first coating film, and the color of the second coating film as input data and the actual appraisal prices of vehicles having specifications that match the input data other than the color of the second coating film on the first market as the training data. The third appraisal model 380 according to the modification is constructed in such a way that an estimated value representing the merit that the second user can remove the second coating film at a desired time to restore the first coating film in a fine condition is added to the actual appraisal price on the first market (corresponding to the second residual value in the first embodiment) in addition to an estimated value representing the merit of protecting the first coating film by the second coating film (corresponding to the first difference in the first embodiment).

The third appraisal model 380 corresponds to the second model according to the present disclosure.

Referring back to FIG. 13, according to this modification, when the color of the second coating film is specified in Entry Item 4 in the first web page, the controller 310 obtains the vehicle information (i.e. the model ID, the grade, the lease term length, the color of the first coating film, and the color of the second coating film). The controller 310 inputs the obtained vehicle information to the third appraisal model 380 to obtain the first residual value. The second residual value is obtained in the same manner as the modification of the first embodiment described above. The first difference, the first subtraction value, the second fee, the first fee, and the monthly lease fee are obtained or calculated in the same manner as the second embodiment as described above.

The system according to the modification can operate in the same manner as the system according to the second embodiment described above and accomplish the same advantageous effects as the system according to the embodiment.

### <Others>

The above embodiment has been described only by way of example. The technology disclosed herein can be implemented in modified manners without departing from the essence of this disclosure. For example, the processing executed in the server 300 may be partly executed in the user's terminal 200 in which a special application program is installed. Specifically, among the steps of processing executed in the server apparatus 300, the processing of subtracting the first subtraction value from the second fee to calculate the first fee may be executed by the special application program executed in the user's terminal 200.

The features of the embodiments and their modifications described above may be adopted in desired combinations, if it is technically feasible to do so. For example, the features of the first and second embodiments may be adopted in any feasible combination. For example, the first fee may be calculated selectively according to either the first or second embodiment depending on the relationship between the useful life of the second coating film and the lease term length. Specifically, when the remaining life calculated as the useful life minus the lease term length is longer than a specific length of period (e.g. between one and three years), the server 300 may calculate the first fee according to the second embodiment, and when the remaining life is shorter than the specific length of period, the server 300 may calculate the first fee according to the first embodiment.

One or some of the processes that have been described as processes performed by one apparatus may be performed by a plurality of apparatuses in a distributed manner. One or some of the processes that have been described as processes performed by different apparatuses may be performed by one apparatus. The hardware configuration used to implement various functions in a computer system may be modified flexibly.

The technology disclosed herein can be implemented by supplying a computer program (information processing program) or programs configured to implement the functions described in the above description of the embodiments to a computer to cause one or more processors of the computer to read out and execute the program or programs. Such a computer program or programs may be supplied to the computer by a non-transitory, computer-readable storage medium that can be connected to a system bus of the computer or through a network. The non-transitory, computer-readable storage medium is a recording medium that can store information such as data and programs electrically, magnetically, optically, mechanically, or chemically in a computer-readable manner. Examples of such a recording medium include any type of discs including magnetic discs, such as a floppy disc (registered trademark) and a hard disk drive (HDD), and optical discs, such as a CD-ROM, a DVD, and a Blu-ray disc. The non-transitory, computer-readable storage medium may also be a ROM, a RAM, an EPROM, an EEPROM, a magnetic card, a flash memory, an optical card, an SSD (Solid State Drive), or other medium.

What is claimed is:

1. An information processing apparatus for calculating a fee for applying a second coating film including an easily removable layer to a first vehicle having a first coating film applied thereon, comprising a controller including at least one processor, wherein
the controller is configured to calculate a first fee defined as a fee for applying the second coating film to the first vehicle when it is for lease lower than a second fee defined as a fee for applying the second coating film to the first vehicle when it is not for lease.

2. The information processing apparatus according to claim 1, wherein the controller calculates the first fee by subtracting a first subtraction value from the second fee.

3. The information processing apparatus according to claim 2, wherein the controller is configured to execute the processing of:
obtaining a first residual value defined as a predicted value of the appraisal price of the first vehicle at the end of the lease term that is predicted under the assumption that the second coating film is applied to the first vehicle; and
calculating the first subtraction value based on the first residual value.

4. The information processing apparatus according to claim 3, wherein the larger the excess of the first residual value over a second residual value is, the larger the controller is configured to calculate the first subtraction value.

5. The information processing apparatus according to claim 4, wherein the second residual value is a predicted value of the appraisal price of the first vehicle at the end of the lease term that is predicted under the assumption that the second coating film is not applied to the first vehicle.

6. The information processing apparatus according to claim 5, further comprising a first database that stores colors of the first coating film, lease term lengths, and first residual values in a linked manner, wherein the controller is configured to execute the processing of:
obtaining the color of the first coating film of the first vehicle and the lease term length of the first vehicle; and
obtaining the first residual value based on the color of the first coating film of the first vehicle, the lease term length of the first vehicle, and the information stored in the first database.

7. The information processing apparatus according to claim 5, further comprising a second database that stores colors of the first coating film, colors of the second coating film, lease term lengths, and first residual values in a linked manner, wherein the controller is configured to execute the processing of:
obtaining the color of the first coating film of the first vehicle, the color of the second coating film to be applied to the first vehicle, and the lease term length of the first vehicle; and
obtaining the first residual value based on the color of the first coating film of the first vehicle, the color of the second coating film to be applied to the first vehicle, the lease term length of the first vehicle, and the information stored in the second database.

8. The information processing apparatus according to claim 5, wherein the controller is configured to execute the processing of:
obtaining the color of the first coating film of the first vehicle and the lease term length of the first vehicle; and
obtaining the first residual value using a first model that takes the color of the first coating film and the lease term length as inputs, and outputs the first residual value, the first model being trained using actual appraisal prices on a first market as the training data.

9. The information processing apparatus according to claim 5, wherein the controller is configured to execute the processing of:
obtaining the color of the first coating film of the first vehicle, the color of the second coating film to be applied to the first vehicle, and the lease term length of the first vehicle; and
obtaining the first residual value using a second model that takes the color of the first coating film, the color of the second coating film, and the lease term length as inputs, and outputs the first residual value, the second model being trained using actual appraisal prices on a first market as the training data.

10. The information processing apparatus according to claim 1, wherein the controller is configured to cause a browser on a user's terminal used by a user of the first vehicle to display a web page that indicates both the first fee and the second fee.

11. The information processing apparatus according to claim 1, wherein the controller is configured to determine a monthly fee for leasing the first vehicle based on the first fee.

12. An information processing method for calculating a fee for applying a second coating film including an easily removable layer to a first vehicle having a first coating film applied thereon by a computer, wherein the computer calculates a first fee defined as a fee for applying the second coating film to the first vehicle when it is for lease lower than a second fee defined as a fee for applying the second coating film to the first vehicle when it is not for lease.

13. The information processing method according to claim 12, wherein the computer calculates the first fee by subtracting a first subtraction value from the second fee.

14. The information processing method according to claim 13, wherein the computer executes the processing of:
obtaining a first residual value defined as a predicted value of the appraisal price of the first vehicle at the end of the lease term that is predicted under the assumption that the second coating film is applied to the first vehicle; and
calculating the first subtraction value based on the first residual value.

15. The information processing method according to claim 14, wherein the larger the excess of the first residual value over a second residual value is, the larger the computer calculates the first subtraction value.

16. The information processing method according to claim 15, wherein the second residual value is a predicted value of the appraisal price of the first vehicle at the end of the lease term that is predicted under the assumption that the second coating film is not applied to the first vehicle.

17. The information processing method according to claim 16, wherein the computer further has a first database that stores colors of the first coating film, lease term lengths, and first residual values in a linked manner, wherein the computer executes the processing of:
obtaining the color of the first coating film of the first vehicle and the lease term length of the first vehicle; and
obtaining the first residual value based on the color of the first coating film of the first vehicle, the lease term length of the first vehicle, and the information stored in the first database.

18. The information processing method according to claim 16, the computer further has a second database that stores colors of the first coating film, colors of the second coating film, lease term lengths, and first residual values in a linked manner, wherein the computer executes the processing of:
obtaining the color of the first coating film of the first vehicle, the color of the second coating film to be applied to the first vehicle, and the lease term length of the first vehicle; and
obtaining the first residual value based on the color of the first coating film of the first vehicle, the color of the second coating film to be applied to the first vehicle, the lease term length of the first vehicle, and the information stored in the second database.

19. The information processing method according to claim 16, wherein the computer executes the processing of:
obtaining the color of the first coating film of the first vehicle and the lease term length of the first vehicle; and
obtaining the first residual value using a first model that takes the color of the first coating film and the lease term length as inputs, and outputs the first residual value, the first model being trained using actual appraisal prices on a first market as the training data.

20. The information processing method according to claim 16, wherein the computer executes the processing of:
obtaining the color of the first coating film of the first vehicle, the color of the second coating film of the first vehicle, and the lease term length of the first vehicle; and
obtaining the first residual value using a second model that takes the color of the first coating film, the color of the second coating film, and the lease term length as inputs, and outputs the first residual value, the second model being trained using actual appraisal prices on a first market as the training data.
